(19) United States
(12) Patent Application Publication
(10) Pub. No.: US 2008/0095442 A1
(43) Pub. Date: Apr. 24, 2008

(54) Detection and Modification of Text in a Image

(75) Inventors: Ahmet Ekin, Eindhoven (NL); Radu Jasinschi, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/718,916

(22) PCT Filed: Nov. 8, 2005
(86) PCT No.: PCT/IB05/53661

§ 371 Date: May 9, 2007

(30) Foreign Application Priority Data
Nov. 15, 2004 (EP) 04105759.7

(51) Int. Cl. G06K 9/00

(52) U.S. Cl. 382/187

(57) ABSTRACT

The method of the invention comprises two steps of adapting an image: identifying a text in the image and modifying a typographical aspect of the text. The electronic device of the invention is operative to perform the method of the invention. The invention also relates to control software for making a programmable device operative to perform the method of the invention and to electronic circuitry for use in the device of the invention.

The invention relates to a method of adapting an image.

The invention also relates to control software for making a programmable device operative to perform such a method.

The invention further relates to an electronic device comprising electronic circuitry operative to adapt an image.

The invention also relates to electronic circuitry for use in such a device.

An example of such a method is known from US 2003/0021586. The known method controls the display of closed captions and subtitles for a combination system of optical or other recording/reproducing apparatus and a television. The known method ensures that the displayed closed captions and subtitles that both exist as text in ASCII format do not overlap. The known method has the drawback that it cannot be used to control the display of closed captions and subtitles if the subtitles form an integral part of the image.

It is a first object of the invention to provide a method of the type described in the opening paragraph, which can be used to control the display of text forming an integral part of the image.

It is a second object of the invention to provide an electronic device of the type described in the opening paragraph, which can be used to control the display of text forming an integral part of the image.

According to the invention, the first object is realized in that the method comprises the steps of identifying a text in the image, the text having a typographical aspect, and modifying the typographical aspect of the text. Analog video material (e.g. analog video broadcasts or analog video tapes) often contains overlay captions and/or subtitles. The method of the invention makes it possible to customize the appearance of overlay text on a display.

In an embodiment of the method of the invention, the typographical aspect comprises font size. The typographical aspect may additionally or alternatively comprise, for example, font type and/or font color. Increasing the font size makes the text easier to read for people who have difficulty reading and/or who use devices with small displays, e.g. mobile phones.

The step of identifying a text in the image may comprise detecting horizontal text line boundaries by determining which ones of a plurality of image lines comprise a highest number of horizontal edges. This improves the text detection performance of the identifying step. By first detecting horizontal text line boundaries, the area that has to be processed in the next step of the text detection algorithm can be relatively small. The inventive idea of detecting horizontal text line boundaries in order to decrease the area that has to be processed, and embodiments of this idea, can also be used without the need to modify the typographical aspect of the text, e.g. when it is used in multimedia indexing and retrieval applications.

The step of identifying a text in the image may further comprise determining a set of pixel values only occurring between the horizontal text line boundaries and identifying pixels as text pixels if the pixels have a value from said set of pixel values. Unlike some alternative text detection algorithms, this text detection algorithm makes it possible to detect inverted text as well as normal text.

The step of identifying a text in the image may further comprise determining a word boundary by performing a morphological closing operation on the identified text pixels and identifying further pixels as text pixels if the further pixels are located within the word boundary. This ensures that a larger number of the text pixels in the video image can be correctly identified.

The step of modifying the typographical aspect of the text may comprise processing text pixels, which form the text, and overlaying the processed pixels on the image. This is useful for adapting images that are composed of pixels.

The method of the invention may further comprise the step of replacing at least one of the text pixels with a replacement pixel, the value of the replacement pixel being based on a value of a non-text pixel, i.e. a pixel which did not form the text. Removal of original text may be necessary if the reformatted text does not completely overlap the original text. By using a replacement pixel, which is based on a value of a non-text pixel, the number of visible artifacts decreases. This inventive way of removing text causes a relatively low number of artifacts and is useful in any application in which text is removed. If a user simply wants to remove subtitles, because he can understand the spoken language, it is not necessary to modify the typographical aspect of the subtitles.

The value of the replacement pixel may be based on a median color of non-text pixels in a neighborhood of the at least one text pixel. In tests, this resulted in replacement pixels that were less noticeable than replacement pixels that were determined with alternative algorithms.

The method of the invention may further comprise the step of replacing a further text pixel in a neighborhood of the replacement pixel with a further replacement pixel, the value of the further replacement pixel being at least partly based on the replacement pixel. Simply increasing the neighborhood size if text pixels have fewer than a pre-determined number of non-text pixels in its neighborhood is not appropriate, because the estimated color may not be accurate if distant background pixels are used, and the larger the neighborhood size, the more computation is needed. If the value of the further replacement pixel is at least partly based on the replacement pixel, and especially if the value of the further replacement pixel is based on a plurality of replacement pixels in the neighborhood of the further replacement pixel, a relatively small neighborhood size is sufficient to achieve a good reduction of visible artifacts.

The step of modifying the typographical aspect of the text may comprise scrolling the text in subsequent images. If the enlarged subtitles or captions have to be fit in their entirety in the video image, the enlargement of the subtitles or captions is limited to a certain maximum. This maximum may be insufficient for some persons. By scrolling the reformatted text pixels in subsequent video images, the text size can be enlarged even further.

The method of the invention may further comprise the step of enabling a user to define a rate at which the text will be scrolled. This allows a user to adjust the rate to his reading speed.

According to the invention, the second object is realized in that the electronic circuitry functionally comprises an identifier for identifying a text in the image, the text having a typographical aspect, and a modifier for modifying the typographical aspect of the text. The electronic device may be, for example, a PC, a television, a set-top box, a video recorder, a video player, or a mobile phone.

These and other aspects of the invention are apparent from and will be further elucidated, by way of example, with reference to the drawings, in which:

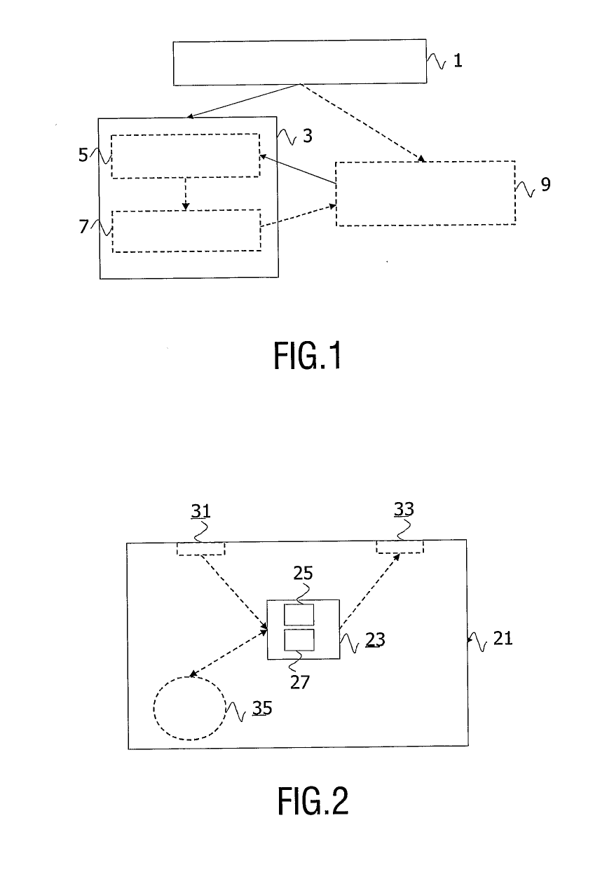

FIG. 1 is a flow chart of the method of the invention;

FIG. 2 is a block diagram of the electronic device of the invention;

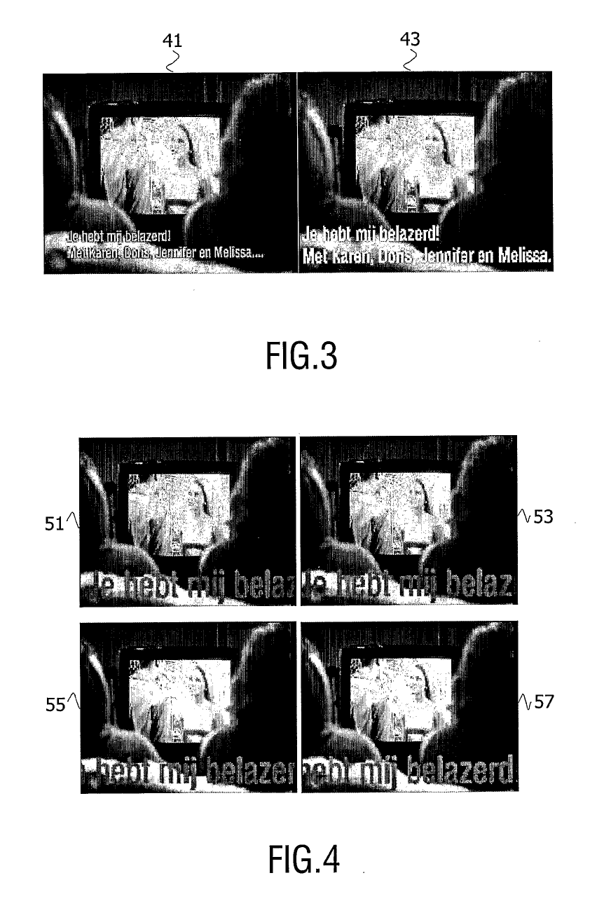

FIG. 3 shows an example of a video image in which subtitles have been enlarged;

FIG. 4 shows an example of video images in which subtitles have been converted to moving text;

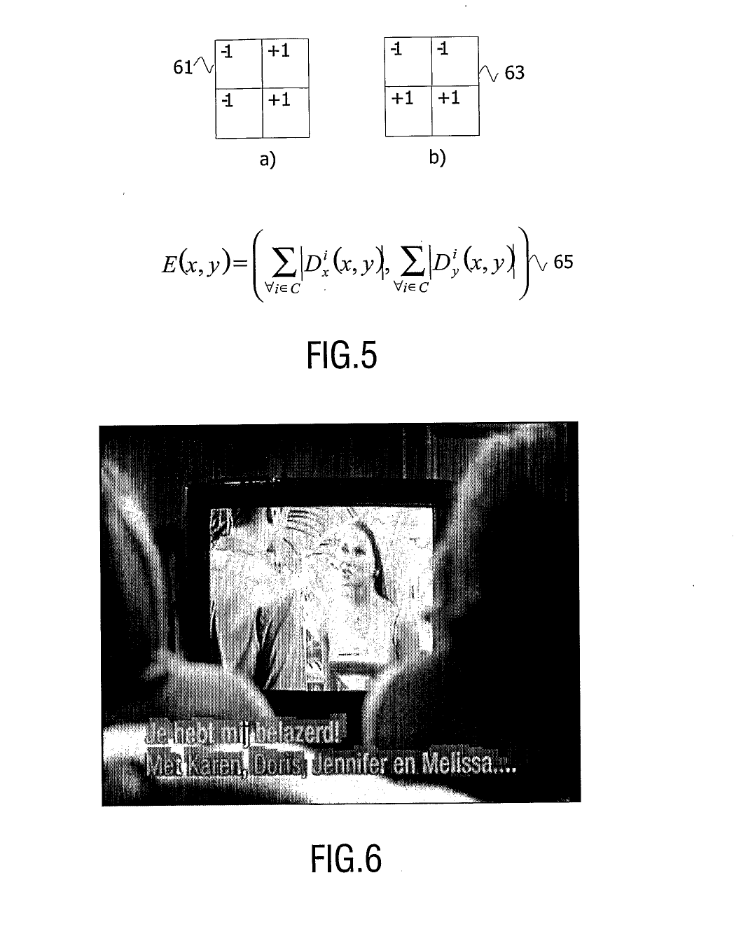

FIG. 5 shows one equation and two masks that are used in a text detection step of an embodiment of the method;

FIG. 6 shows an example of text detected in a video image;

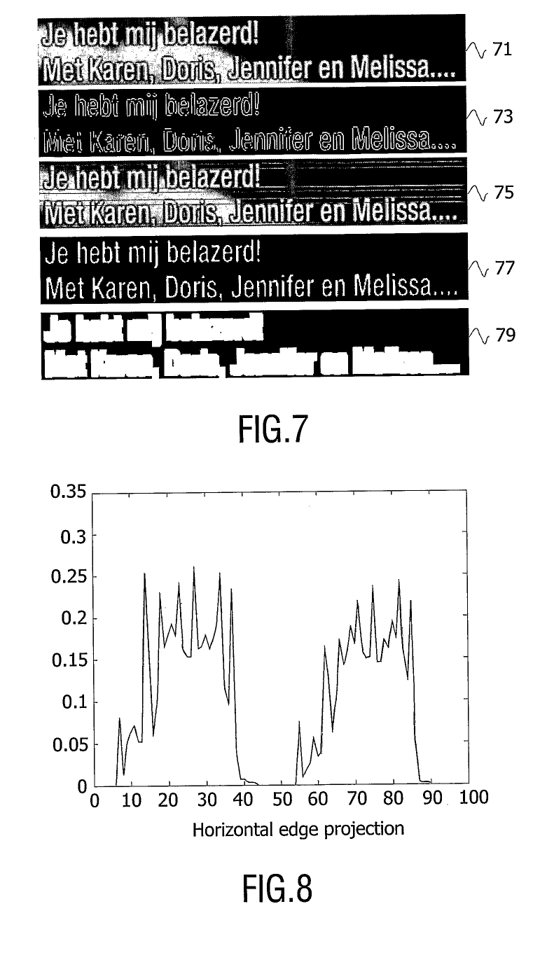

FIG. 7 illustrates the step of identifying text in a region of interest in an embodiment of the method;

FIG. 8 shows a horizontal edge projection calculated for the example of FIG. 7; and

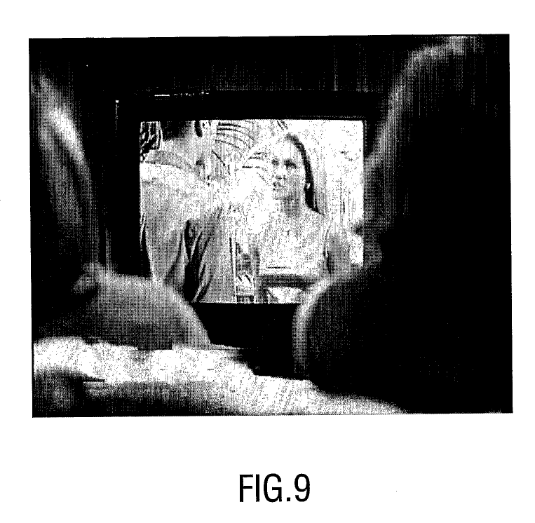

FIG. 9 shows an example of a video image from which identified text pixels have been removed.

Corresponding elements in the drawings are denoted by the same reference numerals.

The method of the invention, see FIG. 1, comprises a step 1 of identifying a text in the image, the text having a typographical aspect, and a step 3 of modifying the typographical aspect of the text. There are many possibilities to reformat the text, including changing of the color, font size, location, etc. FIG. 3 shows an example of where the size and, hence, the location of text is changed. This is especially advantageous on small display screens, e.g. mobile phone displays. The left part of FIG. 3 shows a rescaled version (sub-sampled by a factor of four in both horizontal and vertical directions) of the original image with subtitles. The subtitle character size in the rescaled image becomes much smaller and may be difficult for some users to read. The image in the right part of FIG. 3 is the same image with large-sized subtitles. Advantageously, a consumer electronic device, e.g. a TV, a video recorder, a palmtop or a mobile phone, can perform the method of the invention. Alternatively, a transmitting electronic device performs one part of the method and a receiving (consumer) electronic device performs the other part of the method. In that case, in the method performed by the transmitting electronic device, step 3 of modifying the typographical aspect of the text can be replaced by a step of transmitting the text with a modified typographical aspect to an electronic device which is capable of overlaying the text with the modified typographical aspect on the image.

Step 3 of modifying the typographical aspect of the text may comprise scrolling the text in subsequent images. In FIG. 4, the size of the text in the sub-sampled image is made even larger than the subtitle text size in the original image by converting the static text to moving text. As demonstrated by four images in FIG. 4, originally static subtitle text is transformed to a larger moving text with one or more different colors. The method may further comprise a step of enabling a user to define a rate at which the text will be scrolled. This makes it possible for the user to slow down the scrolling text for a certain period of time. Since a decrease of the velocity of the scrolling text causes delays with respect to real time, text data that lag the real-time text ticker have to be stored in a first-in-first-out (FIFO) memory. The FIFO memory will have a finite size; hence, the duration of the slow-down operation will be limited unless the user agrees on losing some text ticker information to catch up with the real-time ticker. A FIFO memory can be used to store the lagging text data, and algorithms can be used to compute the period of time to use up the whole of the FIFO memory by using parameters, such as font size of moving text, the ratio of the magnitude of the new speed to the original text speed, and memory size. The user can be prompted about such limitations and asked for feedback.

Overlay text detection in video has recently become popular as a result of the increasing demand for automatic video indexing tools. All of the existing text detection algorithms exploit the high contrast property of overlay text regions in one way or another. In a favorable text detection algorithm, the horizontal and vertical derivatives of the frame where text will be detected are computed first in order to enhance the high contrast regions. It is well-known in the image and video-processing literature that simple masks, such as masks 61 and 63 of FIG. 5, approximate the derivative of an image. After the derivatives are computed for each color channel (or intensity and chrominance channels depending on the selected color space), the edge orientation feature is computed by means of equation 65 of FIG. 5, where Dⁱₓ(x,y) and Dⁱ_{y}(x,y) are the horizontal and vertical derivatives for the i^{th} color channel at the pixel location (x,y) and C denotes the set of all channels of the selected color space. The edge orientation feature was first proposed by “Rainer Lienhart and Axel Wernicke. Localizing and Segmenting Text in Images, Videos and Web Pages. IEEE Transactions on Circuits and Systems for Video Technology, Vol. 12, No. 4, pp. 256-268, April 2002.”

A statistical learning tool can be used to find an optimal text/non-text classifier. Support Vector Machines (SVMs) result in binary classifiers and have nice generalization capabilities. An SVM-based classifier trained with 1,000 text blocks and, at most, 3,000 non-text blocks for which edge orientation features are computed, has provided good results in experiments. As it is difficult to find the representative hard-to-classify non-text examples, the popular bootstrapping approach that was introduced by K. K. Sung and T. Poggio in “Example-based learning for view-based human face detection,” IEEE Trans. Pattern Analysis and Machine Intelligence, vol. 20, no. 1, pp. 39-51, January 1998 can be followed. Bootstrap-based training is completed in several iterations and, in each iteration, the resulting classifier is tested on some images that do not contain text. False alarms over this data set represent difficult non-text examples that the current classifier cannot correctly classify. These non-text samples are added to the training set; hence, the non-text training dataset grows and the classifier is retrained with this enlarged dataset. When a classifier is being trained, an important issue to decide upon is the size of the image blocks that are fed to the classifier because the height of the block determines the smallest detectable font size, whereas the width of the block determines the smallest detectable text width. 12×12 Blocks for training the SVM classifier provide good results, because in a typical frame with a height of 400 pixels, it is rare to find a font size which is smaller than 12. Font size independence is achieved by running the classifier with 12×12 window size over multiple resolutions, and location independence is achieved by moving the window in horizontal and vertical directions to evaluate the classifier over the whole image. The described text detection algorithm results in block-based text regions as shown in FIG. 6. The detected text results are shown as green blocks and are obtained from the 2×2, (horizontal sub-sampling rate×vertical sub-sampling rate), sub-sampled video; hence, they correspond to 24×24 blocks in the original frame (12×12 block size for the sub-sampled frame).

Step 1 of identifying a text in the image may comprise detecting horizontal text line boundaries by determining which ones of a plurality of image lines comprise a highest number of horizontal edges. One way of obtaining a pixel-accurate text mask is by specifically locating text line and word boundaries (primarily to be able to display text in multiple lines and to extract the text mask more accurately) and extracting the binary text mask. A morphological analysis can be performed after the text regions in the same line and adjacent rows have been combined to result in a single joint region to be processed. ROI 71 of FIG. 7 shows the region-of-interest (ROI) that is extracted from FIG. 6 by a column-wise and row-wise merging procedure. First, edge detection is performed in the ROI to find the high-frequency pixels most of which are expected to be text. ROI 73 shows the edges, in white, detected by a Prewitt detector known in the art. As the ROI is mainly dominated by text, it is expected that the top of a text line will demonstrate an increase of the number of edges, whereas the bottom of a text line will show a corresponding fall in the number of edges. Projections along horizontal and/or vertical dimensions are effective descriptors to easily determine such locations. In contrast to intensity projections that are used in many text segmentation algorithms, edge projections are robust to the variations in the color of the text. The horizontal edge projection shown in FIG. 8 is computed by finding the average number of edge pixels along each image line, which is shown in ROI 73 of FIG. 7. The two text lines in ROI 71 of FIG. 7 result in two easily extractable edge regions in the projection. ROI 75 of FIG. 7 shows two extracted lines marked with automatically computed red and green lines. The semantics of the four lines per text line follow the properties of Latin text. The first upper line represents the top of the text line; however, at a more detailed level, it corresponds to the tip of the upward-elongated characters, such as ‘t’ and ‘k.’ The second upper line indicates the tip of non-elongated characters, such as ‘a’ and ‘e.’ Similarly, the two lower lines indicate the bottom of the non-elongated characters and the end of downward-elongated characters, such as ‘p’ and ‘y’, or punctuation marks, such as ‘,’.

Step 1 of identifying a text in the image may further comprise determining a set of pixel values only occurring between the horizontal text line boundaries and identifying pixels as text pixels if the pixels have a value from said set of pixel values. After text lines are detected, a threshold T_{binarization} is automatically computed to find the binary and pixel-wise more accurate text mask. The parameter T_{binarization} is set in such a way that no pixel outside the detected text lines shown in ROI 75 of FIG. 7 is assigned as text pixel, e.g. white. The resulting text pixels are shown in ROI 77 of FIG. 7.

Step 1 of identifying a text in the image may further comprise determining a word boundary by performing a morphological closing operation on the identified text pixels and identifying further pixels as text pixels if the further pixels are located within the word boundary. A morphological closing operation, whose result is shown in ROI 79 of FIG. 7, and a connected-component labeling algorithm are applied to the resulting text mask to segment individual words. The closing operation joins separate characters in words, while connected-component labeling algorithm extracts connected regions (words in this case).

Step 1 of modifying the typographical aspect of the text may comprise processing text pixels, which form the text, and overlaying the processed pixels on the image. After or before overlaying the processed pixels on the image, a step 9 of replacing at least one of the text pixels with a replacement pixel may be performed, the value of the replacement pixel being based on a value of a non-text pixel. The value of the replacement pixel may be based on a median color of non-text pixels in a neighborhood of the at least one text pixel. An enlarged text mask as shown in ROI 79 of FIG. 7 can be used for text removal. The enlarged text mask shown in ROI 79 of FIG. 7 is obtained after the application of the morphological closing operation to the original text mask in ROI 77 of FIG. 7. The primary reason to use an enlarged mask is that the original mask may be thinner than the actual text line and, hence, may result in visually unpleasant text pieces in the image from which the original text was removed. To fill text regions, the median color of the non-text pixels is used in a sufficiently large neighborhood of the pixel (e.g. a 23×23 window for a 720×576 image).

The method of the invention may further comprise the step of replacing a further text pixel in a neighborhood of the replacement pixel with a further replacement pixel, the value of the further replacement pixel being at least partly based on the replacement pixel. If the text pixel is distant to the boundary of the text mask, even a large window may then not have enough non-text pixels to approximate the color to be used for filling in the text pixel. Furthermore, the use of larger windows for these pixels is not appropriate because 1) they are far from background so that the estimated color may not be accurate if distant background pixels are used, and 2) the larger the window size, the more computations are needed. In these cases, the median color of these pixels in the small, such as 3×3, neighborhood of the current text pixel is assigned as its color. This neighborhood is defined in accordance with the processing direction so that all text pixels in the neighborhood have already been assigned a color. Note that the color values of all pixels in this small window are used regardless of them originally being text or non-text. The result of this text detection algorithm is shown in FIG. 9.

The electronic device 21 of the invention, see FIG. 2, comprises electronic circuitry 23. The electronic circuitry 23 functionally comprises an identifier 25 for identifying a text in the image, the text having a typographical aspect, and a modifier 27 for modifying the typographical aspect of the text. The electronic device 21 may be, for example, a PC, a television, a set-top box, a video recorder, a video player, or a mobile phone. The electronic circuitry 23 may be, for example, a Philips Trimedia media processor, a Philips Nexperia audio video input processor, an AMD Athlon CPU, or an Intel Pentium CPU. Favorably, the identifier 25 and the modifier 27 are functional components of a computer program. The electronic device 21 may further comprise an input 31, e.g. a SCART, composite, SVHS or component socket or a TV tuner. The electronic device 21 may further comprise an output 33, e.g. a SCART, composite, SVHS or component socket or a wireless transmitter. The electronic device 21 may comprise a display coupled with the electronic circuitry 23 (not shown). The electronic device 21 may also comprise storage means 35. Storage means 35 may be used, for example, for storing unprocessed video images and/or for storing processed video images. The electronic device 21 may comprise an optical character recognition (OCR) unit and a text-to-speech (TTS) unit. The use of OCR is necessary for the operation of TTS because the input to TTS is ASCII text in the form of words and sentences. One application of the OCR and TTS units is that a user having a poor reading ability may choose to listen to automatically generated speech segments in his own native language rather than reading the subtitles. In order to prevent interference from the original audio, the original audio is preferably turned off in these cases. Furthermore, recognizing characters by an OCR engine also allows automatic indexing of video content that makes various applications possible. The electronic device 21 can also be realized by means of two electronic devices. In a first electronic device, electronic circuitry functionally comprises an identifier for identifying a text in the image, the text having a typographical aspect and a transmitter for transmitting both the text with a modified typographical aspect and an identification identifying the image to an electronic device which is capable of overlaying the text with the modified typographical aspect on the image. In a second electronic device, electronic circuitry functionally comprises a receiver for receiving a text with a modified typographical aspect and an identification identifying an image and an overlayer for overlaying the text with the modified typographical aspect on the image. For example, both electronic devices may be part of the same home network, or the first electronic device may be remotely located at a service provider location, while the second electronic device is located in a home network.

While the invention has been described in connection with favorable embodiments, it will be understood that modifications thereof within the principles outlined above will be evident to those skilled in the art, and thus the invention is not limited to the favorable embodiments but is intended to encompass such modifications. The invention resides in each and every novel characteristic feature and each and every combination of characteristic features. Reference numerals in the claims do not limit their protective scope. Use of the verb “to comprise” and its conjugations does not exclude the presence of elements other than those stated in the claims. Use of the article “a” or “an” preceding an element does not exclude the presence of a plurality of such elements.

The invention can be implemented by means of hardware comprising several distinct elements, and by means of a suitably programmed device, ‘Control software’ is to be understood to mean any software product stored on a computer-readable medium, such as a floppy disk, downloadable via a network, such as the Internet, or marketable in any other manner.

1. A method of adapting an image, the method comprising the steps of:
identifying (1) a text in the image, the text having a typographical aspect; and
modifying (3) the typographical aspect of the text.

2. A method as claimed in claim 1, characterized in that the typographical aspect comprises font size.

3. A method as claimed in claim 1, characterized in that the step of identifying (1) a text in the image comprises detecting horizontal text line boundaries by determining which ones of a plurality of image lines comprise a highest number of horizontal edges.

4. A method as claimed in claim 3, characterized in that the step of identifying (1) a text in the image further comprises determining a set of pixel values only occurring between the horizontal text line boundaries and identifying pixels as text pixels if the pixels have a value from said set of pixel values.

5. A method as claimed in claim 4, characterized in that the step of identifying (1) a text in the image further comprises determining a word boundary by performing a morphological closing operation on the identified text pixels and identifying further pixels as text pixels if the further pixels are located within the word boundary.

6. A method as claimed in claim 1, characterized in that the step of modifying the typographical aspect of the text comprises processing (5) text pixels, which form the text, and overlaying (7) the processed pixels on the image.

7. A method as claimed in claim 6, further comprising the step of replacing (9) at least one of the text pixels with a replacement pixel, the value of the replacement pixel being based on a value of a non-text pixel.

8. A method as claimed in claim 7, characterized in that the value of the replacement pixel is based on a median color of non-text pixels in a neighborhood of the at least one text pixel.

9. A method as claimed in claim 7, further comprising the step of replacing a further text pixel in a neighborhood of the replacement pixel with a further replacement pixel, the value of the further replacement pixel being at least partly based on the replacement pixel.

10. A method as claimed in claim 1, characterized in that the step of modifying (3) the typographical aspect of the text comprises scrolling the text in subsequent images.

11. A method as claimed in claim 10, further comprising the step of enabling a user to define a rate at which the text will be scrolled.

12. A method of enabling to adapt an image, the method comprising the steps of:
identifying (1) a text in the image, the text having a typographical aspect; and
transmitting the text with a modified typographical aspect to an electronic device which is capable of overlaying the text with the modified typographical aspect on the image.

13. Control software for making a programmable device operative to perform the method of claim 1.

14. An electronic device (21) comprising electronic circuitry (23), the electronic circuitry (23) functionally comprising:
an identifier (25) for identifying a text in the image, the text having a typographical aspect; and
a modifier (27) for modifying the typographical aspect of the text.

15. An electronic device comprising electronic circuitry, the electronic circuitry functionally comprising:
a receiver for receiving a text with a modified typographical aspect and an identification identifying an image; and
an overlayer for overlaying the text with the modified typographical aspect on the image.

16. An electronic device comprising electronic circuitry, the electronic circuitry functionally comprising:
an identifier for identifying a text in an image, the text having a typographical aspect; and
a transmitter for transmitting both the text with a modified typographical aspect and an identification identifying the image to an electronic device which is capable of overlaying the text with the modified typographical aspect on the image.

17. Electronic circuitry for use in the electronic device of claim 1.
